(19) United States
(12) Patent Application Publication
(10) Pub. No.: US 2005/0236808 A1
(43) Pub. Date: Oct. 27, 2005

(54) Coupling assembly for vehicles

(76) Inventors: Johan Lier, Staphorst (NL); Gerrit Albartus Hemstede, Staphorst (NL)

Correspondence Address: LADAS & PARRY, 26 WEST 61ST STREET, NEW YORK, NY, 10023, US

(21) Appl. No.: 10/528,049

(22) PCT Filed: Sep. 17, 2003
(86) PCT No.: PCT/NL03/00645

§ 371 Date: Mar. 16, 2005

(30) Foreign Application Priority Data
Sep. 17, 2002 (NL) 1021479

(51) Int. Cl. B60D 1/00

(52) U.S. Cl. 280/495

(57) ABSTRACT

Coupling assembly (1) for vehicles, comprising a vehicle, the coupling assembly (1) comprising a first coupling member (20) provided with a connection member for a car trailer or an accessory, such as a bike rack, and a second coupling member (5) with which the first coupling member can be couple to connect it to the vehicle, the vehicle comprising a chassis (100) having a transverse beam (4) situated at the rear side of the vehicle, the second coupling member (5) being permanently or undetachably attached in the transverse beam (4).

The invention relates to a coupling assembly for vehicles, such as for a tow hitch facility.

Coupling assemblies for vehicles have been generally known and for quite some time already. Usually the coupling assemblies are adjusted to use for towing car trailers, by means of a tow hitch. Such assemblies used to be permanent, but later on two-part tow hitch assemblies were brought onto the market consisting of an accommodation part that was permanently attached to the vehicle and a detachable tow hitch member, that could be coupled into the accommodation part for use, and after use could be uncoupled in order to be stowed away. In that way the tow hitch, when inoperative, does not constitute an obstacle to persons passing the vehicle at the rear. Moreover it is not allowed that the hitch ball fully or partially covers the license plate.

An example of such a tow hitch assembly is described in European patent application 0.950.549 the contents of which should be deemed included here.

In the existing tow hitch assemblies that can be uncoupled, the accommodation part is attached to the new or old vehicle by means of a transverse beam, which extends at the front below the rear bumper and at the ends and at intermediate locations is attached to the rear side of the chassis of the vehicle.

The existing tow hitch assemblies—that may or may not be uncoupable—increase the standard weight of the vehicle, particularly as a result of transverse beam. The transverse beam hanging behind the chassis may form a protruding hindrance when the rear side of the vehicle passes over the ground.

Another drawback of the existing tow hitch assemblies is that they require a lot of mounting operations, which particularly renders the fitting of a tow hitch assembly at a later stage, expensive.

It is an objective of the invention to improve on this.

From one aspect the invention to that end provides an assembly of a vehicle and a coupling assembly for it, the coupling assembly comprising a first coupling member provided with a connection member for a car trailer or an accessory, such as a bike rack, and a second coupling member with which the first coupling member can be coupled to connect it to the vehicle, the vehicle comprising a chassis having a transverse beam situated at the rear side of the vehicle, the second coupling member being permanently or undetachably attached to the transverse beam.

Due to the integration of the permanently vehicle-fixed second coupling member with the supporting structure of the vehicle, particularly the chassis transverse beam, the usual additional transverse beam for mounting the tow hitch assembly can be dispensed with. This results in a weight reduction. The second coupling member can easily (easily accessible, because of at the building stage of the vehicle) and serially be secured. The vehicle is as it were “tow hitch prepped”, the consumer can then buy the desired accessory, such as a hitch ball, at a moment that suits him or her. Particular mounting activities are no longer necessary then. Due to the early integration of the second coupling member, the strength of the chassis transverse beam can be utilised—possibly after adjusted design—for the transfer of forces during use.

The quantity of the stock to be kept by the dealer can be kept limited, as only one part of the coupling assembly has to be kept available.

Preferably the second coupling member is welded fixed to the transverse beam.

Preferably the second coupling member is placed in the transverse beam, as a result of which the occupation of space can be kept very limited.

Preferably the transverse beam is tubular having a first wall and an opposite second wall, the second coupling member being permanently or undetachably attached, such as by means of welding, to the first wall and/or to the second wall. In case of attachment to both walls the forces during use can be transferred to the chassis beam at two—in cross-section—spaced apart locations.

The first wall and the second wall of the tubular transverse beam may form an upper wall and a lower wall, respectively, of the transverse beam.

Advantageously the second coupling member is provided with a placement flange, as a result of which the mounting of the second coupling member is facilitated. If the second coupling member is a steel casting the flange shortens the decarbonization path after casting the second coupling member, which decarbonization is necessary in order to render the material fit for welding.

The second coupling member may furthermore be provided with an eye for a hauling or towing cable, by which means several facilities may be placed in one go: separately arranging a towing eye is no longer necessary. Moreover use can be made of the strength of the location of transfer of forces for the hitch ball and the like on the chassis.

In the tubular design of the transverse beam a third wall connecting the first and second wall of the transverse beam can be provided with an opening for access to the eye, the eye preferably extending at least partially through the opening to the outside. Here as well space can be saved on.

The second coupling member preferably is furthermore provided with one or more means for attachment of a safety cable, so that they have been present ever since the production of the vehicle.

Preferably the first coupling member can be detachably coupled to the second coupling member, so that it is possible to change the first coupling member.

Preferably the first coupling member is dividable into a first part that can be coupled to the second coupling member and a second part that can be connected to an operation member, such as a hitch ball. Thus the coupling assembly becomes more versatile, and the user is able to choose the wanted function by only selecting a small part of the assembly.

In a further development thereof, the second part is plate-shaped and provided with holes for bolts for attachment of the operation member. As a result many different selected operation members provided with an attachment plate can be used, and attached at a desired height.

In an alternative further development the second part defines an accommodation sleeve for accommodation of an insertion member of the operation member. As a result many different selected operation members provided with an attachment rod can be used, and attached at a desired height.

The second coupling member can be made of steel, particularly metal, and obtained by injection moulding. In this way the wanted shape can easily be achieved, with the desired strength.

In a further development the first coupling member may comprise an insertion member and the second coupling member comprises an accommodation member, in which the insertion member can be coupled in the accommodation member. In this way a stable coupling can be realised.

The invention furthermore provides a coupling assembly suitable and intended for an assembly according to the invention.

From a further aspect the invention provides a vehicle having a chassis, the chassis being provided with a coupling member that is permanently fixed and undetachably connected to it, for detachable coupling to a further coupling member for a connection member for an accessory, such as a car trailer or bike rack, to be taken along by the vehicle, such as by towing or carrying.

Preferably the chassis comprises a transverse beam situated at the rear, the coupling member being fixedly attached, preferably welded fixed, to the transverse beam. The coupling member may be welded fixed to the transverse beam using a placement flange that forms a unity therewith.

Preferably the transverse beam is tubular and the coupling member extends into the transverse beam. The transverse beam may be polygonal in cross-section, the coupling member being permanently or undetachably attached to at least two of the sides of the polygon.

From a further aspect the invention provides a coupling member suitable and intended for a coupling assembly or vehicle according to the invention.

From a further aspect the application provides an assembly of a vehicle and a coupling assembly for it, the coupling assembly being provided with an eye for a hauling or towing cable. In that way it is possible to simultaneously in one go, together with the attachment of the coupling assembly, particularly with a tow hitch, provide such an eye on a vehicle.

Further efficiency is achieved when the coupling assembly is furthermore provided with one or more means for attaching a safety cable.

Preferably the coupling assembly comprises a first coupling member provided with a connection part for a car trailer or an accessory, such as a bike rack, and a second coupling member with which the first coupling member can be coupled in order to connect it to the vehicle, the eye and/or means for attaching a safety cable forming a unity with the second coupling member.

Transfer of forces onto the eye and the like is enhanced when the vehicle comprises a chassis having a transverse beam situated at the rear side of the vehicle, the second coupling member being permanently or undetachably connected to the transverse beam.

The application furthermore relates to a coupling assembly for vehicles, provided with one or more measures as described above, particularly the eye for a hauling cable.

The invention will be elucidated on the basis of an exemplary embodiment shown in the attached drawings, in which:

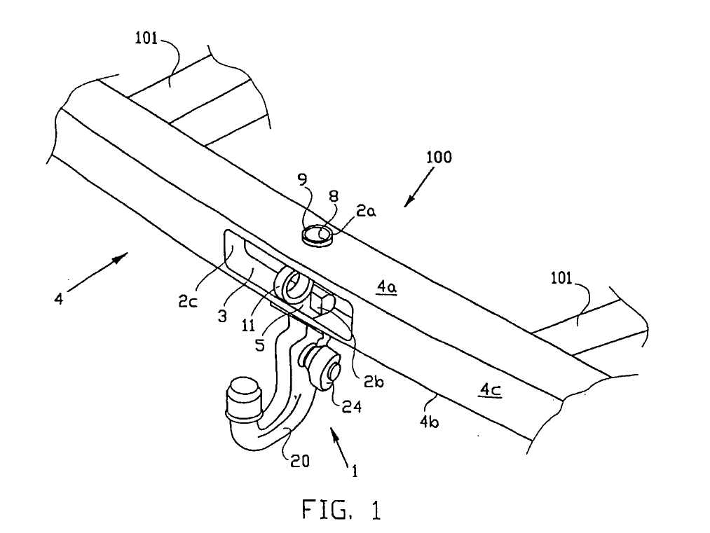

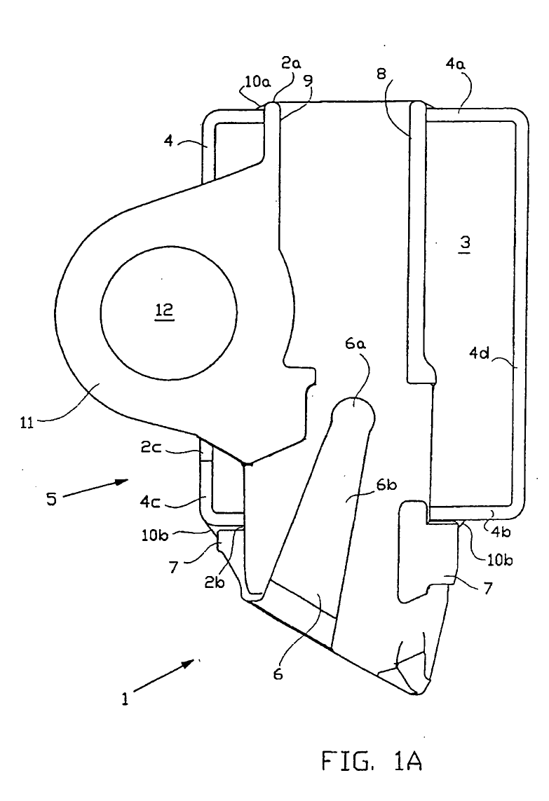

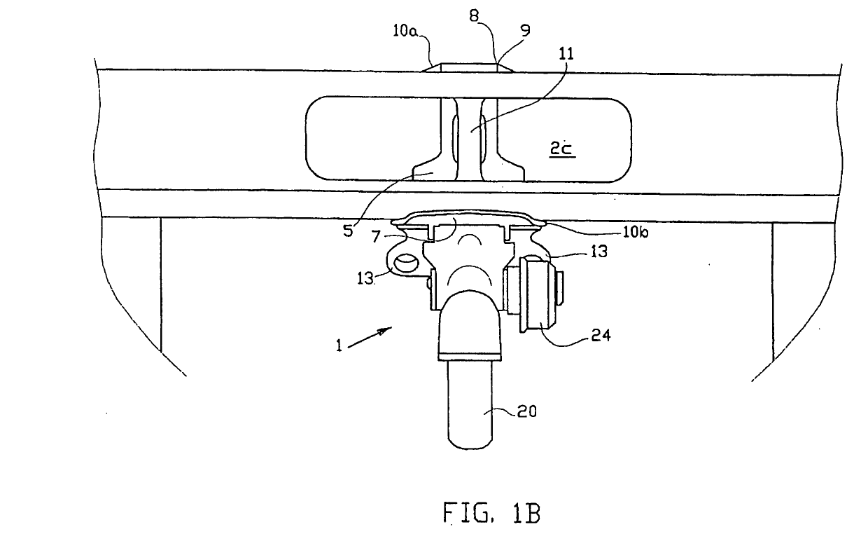

FIG. 1 shows a schematic inclined view of the rear side of a chassis of an automobile, in which a coupling assembly according to the invention has been incorporated;

FIG. 1A shows a detail of a coupling assembly substantially as shown in FIG. 1, with uncoupled operation member;

FIG. 1B shows a straight rear view of the arrangement of FIG. 1

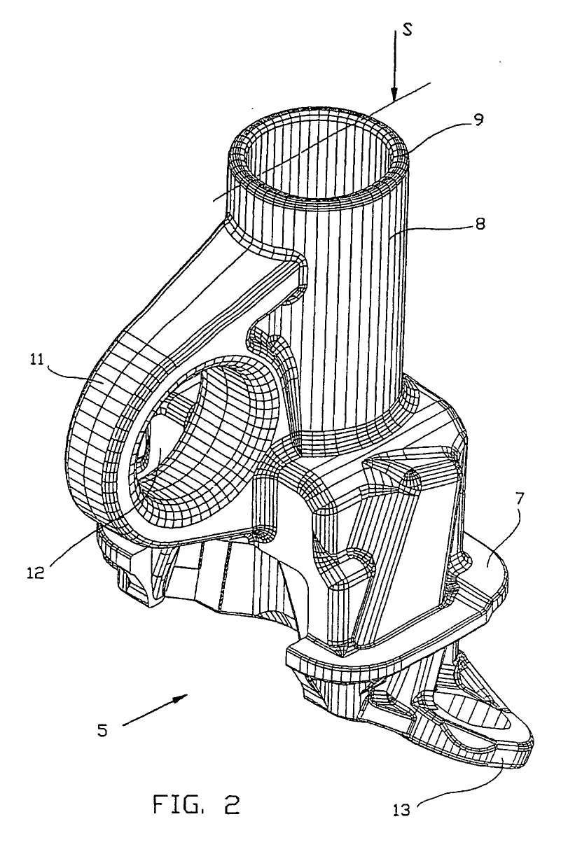

FIG. 2 shows a view in perspective of the permanent coupling member of the coupling assembly of FIG. 1;

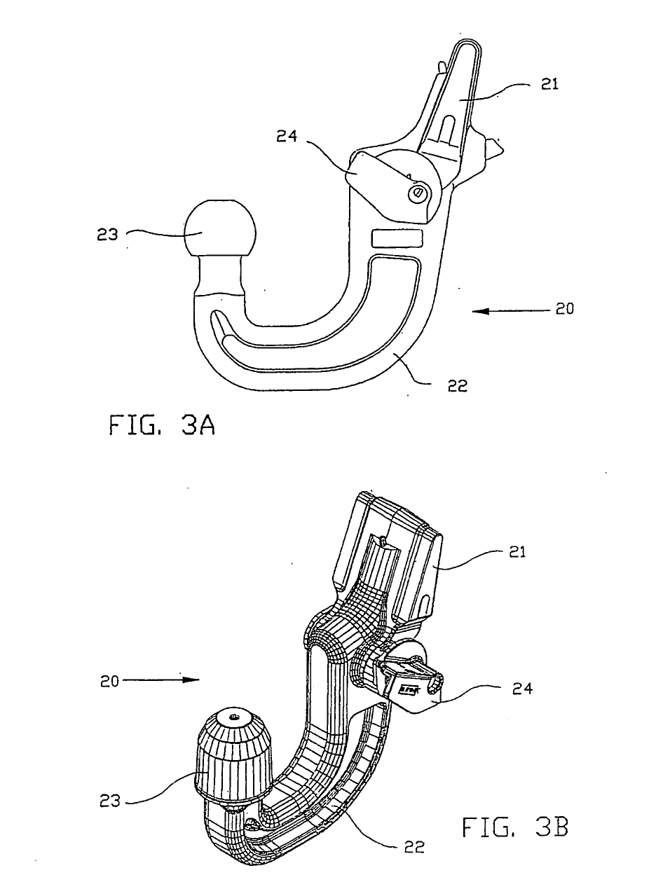

FIGS. 3A and 3B show a first embodiment of an operation member for a coupling assembly according to the invention;

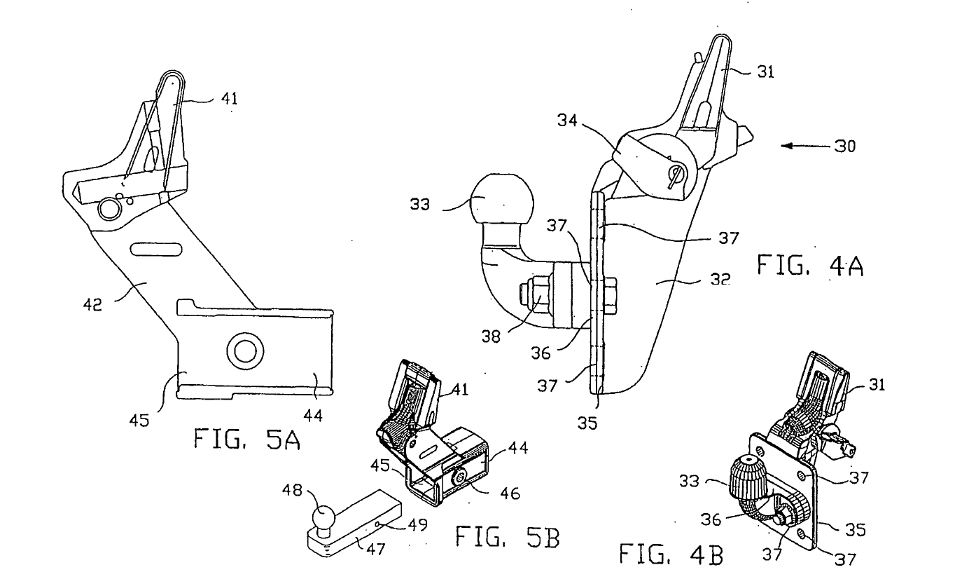

FIGS. 4A and 4B show a second example of an operation member for a coupling assembly according to the invention; and

FIGS. 5A and 5B show (a part of) another operation member for a coupling assembly according to the invention.

FIG. 1 shows a chassis 100 of a vehicle, chassis 100 comprising longitudinal beams 101 and a centrally situated transverse beam 4. The transverse beam 4 is made of steel and has a tubular profile having inner space 3.

At the chassis transverse beam 4 a preferred embodiment of a coupling assembly 1 according to the invention has been attached. The coupling assembly 1 consist of an accommodation member 5, which is permanently attached to the chassis transverse beam 4 and which is made of cast steel, and, by way of example, an operation member 20 that can be detachably coupled in said accommodation member.

As can be seen in FIG. 1A and FIG. 2, the accommodation member 5 is hollow, having a tubular portion 8 and below it an accommodation space 6 in which the coupling end of an operation member that is not shown in these figures can be inserted. The accommodation member 5 is formed as one unity with a towing eye 11, having a continuous opening 12 for attaching a towing cable or the like.

The accommodation space 6 has accommodation slits 6b in two opposite walls, which accommodation slits 6b end blindly at the location of 6a. Said grooves are intended for the fitting accommodation of an insertion member of the operation member, as can also be seen in European patent 950.549.

At the location of upper edge 9 of the tubular portion 8, the accommodation member 5 is welded fixed to upper wall 4a of chassis transverse beam 4 by means of circumferential weld seam 10a.

Around the accommodation part 6 the accommodation member 5 is provided with a circumferential flange 7, which by means of circumferential weld 10b is welded fixed to lower wall 4b of the chassis transverse beam 4. Instead of welding, depending on the materials used, glue can also be used in order to realise the wanted permanent, undetachable connection.

Note that the circumferential flange 7 in the FIGS. 1 and 1B is buckled at the rear side, in order to fit on the rear wall 4c that is also buckled. In the rear wall 4c the chassis transverse beam 4 has been provided with a broad recess 2c, through which the towing eye can extend.

For inserting the coupling member 5 into the inner space 3, the coupling member 5 is inserted from below into a suitably broad hole 2b, the tubular portion 8 coming first, until the flange 7 abuts the lower surface of the lower wall 4b. The tubular portion 8 with upper edge 9 then fittingly extends into the hole 2a. Then the welds 10a and 10b are made. Despite the broad hole 2a the flange 7 provides sufficient engagement with the wall 4b.

It is also possible to use a two-part design of the chassis transverse beam 4, the lower wall 4b belonging to a first, lower part and the upper wall 4a belonging to an upper part to be placed and welded fixed thereon. The coupling member with the flange 7 is then first placed against the lower wall 4b, the weld 10b is made, and subsequently the upper part with upper wall 4a is placed, the upper edge 9 of the tubular portion 8 fitting in hole 2a. After that the circumferential weld 10a is made. At locations that are not further shown, both parts of the chassis transverse beam 4 are welded to each other, to form a rigid unity.

Thus the coupling member 5 forms one rigid and strong unity with the chassis transverse beam 4. Forces of the coupling assembly, or a cable attached to a towing eye 11 are directly transferred to the chassis transverse beam 4 via the coupling member 5.

As is also shown in FIG. 2, the accommodation member 5, at a location below the flange 7, is provided with eyes 13, for attachment of safety cables, with which for instance a car trailer can be secured, parallel to the coupling line.

In FIGS. 3A and 3B an operation member 20 is shown which is used a lot on the European continent. The operation member 20 is a tow hitch member here, having an insertion end 21 that can be detachably coupled in accommodation part 6 of coupling member 5. Use is made here of coupling pins 25 and 26, and operation knob 24. The tow hitch member 20 furthermore has a ball 23, as is customary.

The tow hitch member 30 shown in FIGS. 4A and 4B, as regards the insertion member and its operation, corresponds to the tow hitch member of FIGS. 3A and 3B. The tow hitch member 30, however, is divided at the location of plate 35, which is provided with a number of series of holes 37. The actual tow hitch part is provided with a plate 36 having two holes 37, which depending on the desired height are aligned with the holes 37 in plate 36. In that position both members are secured to each other by means of bolts 38. It is possible here to replace the tow hitch part by another accessory, for instance an accessory for carrying a bike rack.

In FIGS. 5A and 5B a so-called American variety is shown, in which the tow hitch member 40 can also be divided, as shown in FIG. 5B. The insertion member 41 is first of all designed to be permanently accommodated in accommodation member 5 of FIG. 1A, which coupling can however take place at a moment that suits the consumer. Alternatively the member 40 can also be provided with uncoupling means.

In the mounted position, the member 40 has plates 42 extending forward and downward in an inclined manner, at the lower end of which a tube section 44 has been attached. The tube section 44 defines an accommodation space 45 for an elongatedly formed tow hitch member 47, which is provided with a continuous hole 49 and with a hitch ball 48. The passage 49 comes in line with passage 46 in the tube member 44, so that a locking pin (not shown) can be inserted into it to secure the tow hitch member 47 to the member 41. By removal of the pin the tow hitch member 47 can be removed again.

Because the chassis transverse beam 4 has already been provided in the factory with an accommodation member 1 for an operation member (of whatever function) the consumer only needs to buy a part of the total coupling assembly and moreover specialised mounting operations can be dispensed with.

1. Assembly of a vehicle and a coupling assembly for it, the coupling assembly comprising a first coupling member provided with a connection member for a car trailer or an accessory, such as a bike rack, and a second coupling member with which the first coupling member can be coupled to connect it to the vehicle, the vehicle comprising a chassis having a transverse beam situated at the rear side of the vehicle, the second coupling member being permanently or undetachably attached to the transverse beam.

2. Coupling assembly according to claim 1, the second coupling member being welded fixed to the transverse beam.

3. Coupling assembly according to claim 1 or 2, the second coupling member being placed in the transverse beam.

4. Coupling assembly according to claim 3, the transverse beam being tubular having a first wall and an opposite second wall, the second coupling member being permanently or undetachably attached, such as by means of welding, to the first wall.

5. Coupling assembly according to claim 3 or 4, the transverse beam being tubular having a first wall and an opposite second wall, the second coupling member being permanently or undetachably attached, such as by means of welding, to the second wall.

6. Coupling assembly according to claim 4 or 5, the first wall and the second wall of the tubular transverse beam forming an upper wall and a lower wall, respectively, of the transverse beam.

7. Assembly according to any one of the preceding claims, the second coupling member furthermore being provided with an eye for a hauling or towing cable.

8. Coupling assembly according to claims 6 and 7, a third wall connecting the first and second wall of the transverse beam being provided with an opening for access to the eye, the eye preferably extending at least partially through the opening to the outside.

9. Assembly according to any one of the preceding claims, the second coupling member being provided with a placement flange for abutment to the outside of the transverse beam, the flange being preferably at least almost circumferential.

10. Assembly according to any one of the preceding claims, the second coupling member furthermore being provided with one or more means for attachment of a safety cable.

11. Assembly according to any one of the preceding claims, in which the first coupling member can be detachably coupled to the second coupling member.

12. Assembly according to any one of the preceding claims, the first coupling member being dividable into a first part that can be coupled to the second coupling member and a second part that can be connected to an operation member, such as a hitch ball.

13. Assembly according to claim 12, the second part being plate-shaped and provided with holes for bolts for attachment of the operation member.

14. Assembly according to claim 12, the second part defining an accommodation sleeve for accommodation of an insertion member of the operation member.

15. Assembly according to any one of the preceding claims, the second coupling member being made of steel, particularly metal, and obtained by injection moulding.

16. Assembly according to any one of the preceding claims, the first coupling member comprising an insertion member and the second coupling member comprising an accommodation member, in which the insertion member can be coupled in the accommodation member.

17. Vehicle having a chassis, the chassis being provided with a coupling member that is permanently fixed and undetachably connected to it, for detachable coupling to a further coupling member for a connection member for an accessory, such as a car trailer or bike rack, to be taken along by the vehicle, such as by towing or carrying.

18. Vehicle according to claim 17, the chassis comprising a transverse beam situated at the rear, the coupling member being fixedly attached to the transverse beam.

19. Vehicle according to claim 18, the coupling member being welded fixed to the transverse beam.

20. Vehicle according to claim 18 or 19, the transverse beam being tubular and the coupling member extending into the transverse beam.

21. Vehicle according to claim 20, the transverse beam being polygonal in cross-section, the coupling member being permanently or undetachably attached to at least two of the sides of the polygon.

22. Vehicle according to claim 19, the coupling member being welded fixed to the transverse beam, by means of a placement flange forming a unity therewith.

23. Vehicle according to any one of the claims 17-22, the coupling member furthermore being provided with an eye for a hauling or towing cable.

24. Vehicle according to any one of the claims 17-22, the coupling member furthermore being provided with one or more means for attaching a safety cable.

25. Coupling member suitable and intended for a coupling assembly according to any one of the claims 1-16.

26. Coupling assembly suitable and intended for an assembly according to any one of the claims 1-16.

27. Coupling member suitable and intended for a vehicle according to any one of the claims 17-24.

28. Assembly of a vehicle and a coupling assembly for it, the coupling assembly being provided with an eye for a hauling or towing cable.

29. Assembly according to claim 28, the coupling assembly furthermore being provided with one or more means for attaching a safety cable.

30. Assembly according to claim 28 or 29, the coupling assembly comprising a tow hitch.

31. Assembly according to claim 28, 29 or 30, the coupling assembly comprising a first coupling member provided with a connection member for a car trailer or an accessory, such as a bike rack, and a second coupling member with which the first coupling member can be coupled to connect it to the vehicle, the eye and/or the means for attaching a safety cable forming a unity with the second coupling member.

32. Assembly according to claim 31, the vehicle comprising a chassis having a transverse beam situated at the rear side of the vehicle, the second coupling member being permanently or undetachably attached to the transverse beam.

33. Coupling assembly for vehicles, provided with one or more of the features as described in any one of the claims 28-32.

34. Coupling assembly provided with one or more of the characterising measures described in the attached description and/or shown in the attached drawings.

35. Vehicle provided with one or more of the characterising measures described in the attached description and/or shown in the attached drawings.
